(19) United States
(12) Patent Application Publication
(10) Pub. No.: US 2022/0014301 A1
(43) Pub. Date: Jan. 13, 2022

(54) OPTICAL COMMUNICATION NODE

(71) Applicant: NIPPON TELEGRAPH AND TELEPHONE CORPORATION, Tokyo (JP)

(72) Inventors: Kazunori SENOO, Musashino-shi, Tokyo (JP); Kenya SUZUKI, Musashino-shi, Tokyo (JP); Keita YAMAGUCHI, Musashino-shi, Tokyo (JP); Takayuki MIZUNO, Musashino-shi, Tokyo (JP); Hirotaka ONO, Musashino-shi (JP); Toshikazu HASHIMOTO, Musashino-shi, Tokyo (JP); Yutaka MIYAMOTO, Musashino-shi, Tokyo (JP)

(73) Assignee: NIPPON TELEGRAPH AND TELEPHONE CORPORATION, Tokyo (JP)

(21) Appl. No.: 17/294,612

(22) PCT Filed: Nov. 13, 2019
(86) PCT No.: PCT/JP2019/044570

§ 371 Date: May 17, 2021

(30) Foreign Application Priority Data
Nov. 20, 2018 (JP) 2018-217699

(51) Int. Cl. H04J 14/02

(52) U.S. Cl. CPC H04J 14/0212

(57) ABSTRACT

When a first connection number of a b-th output port in an a-th wavelength selective switch connected to paths in one side out of a Drop side and an Add side is expressed by f(a, b, k), and a second connection number of a d-th output port in a c-th wavelength selective switch connected to paths in the other side out of the Drop side and the Add side is expressed by g(c, d, k), f(a, b, k)≠g(c, d, k).

### TECHNICAL FIELD

The present invention relates to an optical communication node applicable to wavelength division multiplying networks.

### BACKGROUND ART

In recent years, with construction of large capacity optical communication networks, a wavelength division multiplexing (WDM) communication technology attracts attention, and equipment of WDM system has become popular. Generally, in WDM nodes, an optical signal is not directly controlled. Rather, an optical signal is first converted into an electrical signal, and then route switching of the electrical signal is performed. However, in a system of performing route switching after converting an optical signal into an electrical signal, there are issues of higher load applied to throughput in the nodes, dependence on transmission speed, and increased power consumption.

Accordingly, in order to perform signal processing directly for an optical signal without conversion into an electrical signal and switching, transparent network systems represented by a reconfigurable optical add/drop multiplexer (ROADM) is gaining importance. Moreover, switching devices, such as wavelength selective switches (WSSs), are vigorously being developed as optical devices constituting the ROADM. For example, one example of the WSSs constituting the ROADM in spatial division multiplexing (SDM) communication technology is disclosed in Non-Patent Literature 1.

The basic configuration and principle of operation in an optical signal processing device of the WSS will be described. A WDM signal input from an input optical fiber propagates through space as collimated light in a collimator, passes through a plurality of lenses and a diffraction grating for wavelength demultiplexing, and is then collected via a lens again. At a collecting position of the WDM signal, a spatial light modulator (SLM) is disposed for giving a desired phase change to an optical signal. As the SLM, micro mirror arrays according to micro-electro mechanical system (MEMS) technology, liquid crystal cell arrays, digital mirror devices (DMDs), liquid crystals on silicon (LCOS), or the like, is used.

The SLM gives desired phase change to each of the optical signals, and the optical signals with their phases changed are reflected by the SLM. The reflected optical signals are each incident on a diffraction grating via a lens, and are then wavelength-multiplexed. The wavelength-multiplexed optical signals are each coupled with an output fiber via a lens. In the WSS, at least one input fiber and a plurality of output fibers are arranged. Since the SLM deflects the angle of an optical signal to a desired angle, it is possible to select an output fiber to be coupled with the reflected optical signal and to thereby perform switching.

It is known that some WDM nodes are formed to be mounted with a plurality of optical switches operable as described above. FIG. 1 is a schematic view showing the configuration of a WDM node 100 having a plurality of WSSs mounted on one node. An optical signal incident on the WDM node 100 is set to proceed to a drop or through route by wavelength selection through a WSS group 101. The optical signal dropped in the WSS group 101 goes to a wavelength demultiplexing function unit group 102, where its route to proceed is determined in accordance with wavelengths. The signal is then incident on a receiver group 103 and reaches a desired receiver. Meanwhile, an optical signal transmitted from a transmitter group 104 in the WDM node 100 passes through a wavelength multiplexing function unit group 105, and is then transferred toward an adjacent node (illustration omitted) by a WSS group 106.

When through setting is made in the WDM node 100, an optical signal incident on the WDM node 100 passes through the WSS group 101 disposed on an input side, the WSS group 106 disposed on an output side, and a shuffle wiring unit 107 which connects the WSS group 101 and the WSS group 106 with each other, respectively. Hereinafter, the WSS group 101, the WSS group 106, and the shuffle wiring unit 107 are collectively called a wavelength cross-connect (WXC) function unit 108.

In the WDM node 100, optical signals from a plurality of paths D1, D2, . . . , Dn arranged on a Drop side are input into WSSs which are different from each other in the WSS group 101, respectively. A number n represents any natural number equal to or more than two. A function required for the WXC is a function to switch and output any signal input from any one of the paths D1, D2, . . . , Dn to any one of paths A1, A2, . . . , An. Accordingly, it is necessary that any WSS included in the WSS group 101, for example, a WSS-D1 that receives an optical signal input from the path D1, can switch an output destination of an optical signal to any one of the paths A1, A2, . . . , An which are connected to the WSS group 106. Therefore, all the WSSs included in the WSS group 106 are connected to at least one connection port from each of the WSSs included in the WSS group 101. The paths D2, . . . , Dn also need the above configuration relating to the path D1. In that case, a meshed optical wiring is provided between the WSSs included in the WSS group 101 and WSSs included the WSS group 106, and such optical wiring constitutes the shuffle wiring unit 107. In the past, for the Add side and the Drop side, the WSSs having the same configuration with each other are used. This is because using the same WSS configuration provides such advantages that the number of articles to be retained in a system management site can be reduced, and the speed of replacement at the time of apparatus failure can be increased. Such configuration can implement the WDM node 100 which can output signals of the plurality of paths D1, D2, . . . , Dn to any paths A1, A2, . . . , An.

### CITATION LIST

### Non-Patent Literature

Non-Patent Literature 1: Kenya Suzuki, Keita Yamaguchi, Mitsumasa Nakajima, Kazunori Senoo, Toshikazu Hashimoto, Mitsunori Fukutoku, and Yutaka Miyamoto: “Wavelength selective switching devices for SDM network”, Institute of Electronics, Information and Communication Engineers technical report [Extremely Advanced Optical Transmission Technologies], pp. 14-19 (2017. November).

### SUMMARY OF THE INVENTION

### Technical Problem

However, the conventional WXC including the aforementioned shuffle wiring unit 107 is configured such that single core optical fibers are used as connection ports which connect the WSSs of the WSS group 101 with the WSSs of the WSS group 106 by wiring one port at a time. Such configuration has high extendibility since it can cope with increase or decrease in the number of the paths which are connected to the WDM node 100 by reconfiguration of the connection of the optical fibers. However, an operator works on extremely complicated wiring while performing checking. This leads to a risk of erroneous connection in the configuration where a plurality of optical fibers is wired in a meshed state, and there are such problems that wide space is required and wiring work is labor intensive and time consuming.

A configuration where shuffle wiring is performed typically using a planar lightwave circuit (PLC) is conceivable as a configuration of WXC different from the configuration of a plurality of single core optical fibers being wired in a meshed state. In the configuration using the planar lightwave circuit, wires for connecting the WSSs are constructed in advance as optical waveguides on a planar lightwave circuit in compact configuration. Accordingly, decrease in the risk of erroneous connection and reduction in labor and time of the connection work are expected.

However, in the configuration of the WXC using a planar lightwave circuit, a route passing the PLC causes connection loss. Furthermore, since shuffle wiring needs to be implemented within a prescribed surface of the planar device, the number of crossing times of the optical waveguides becomes extremely large. For example, if crossing loss of the waveguides should be estimated to be about 0.1 dB, and the number of crossing times of the optical waveguides is about one to two, it can be considered that the total value of the crossing loss is in a negligible level. However, when the number of paths becomes ten or more due to expansion in the scale of the WDM node, the number of crossing times of the optical waveguides may exceed 100. In that case, the total value of the crossing loss reaches around 10 dB, which may possibly cause deterioration in optical transmission quality.

The present invention, which has been made in light of the above-mentioned circumstances, provides an optical communication node having low loss and capable of reducing labor and time of a connection work.

### Means for Solving the Problem

An optical communication node of the present invention is an optical communication node having a plurality of paths on a Drop side and a plurality of paths on an Add side, any one of the paths on the Drop side being freely connectable to any one of the paths on the Add side, the number of the paths on one side out of the Drop side and the Add side being m, the number of the paths on another side out of the Drop side and the Add side being k, and the numbers m and k being natural numbers of two or above. The optical communication node includes: at least m wavelength selective switches connected to the paths on the one side and having at least one input port and at least k output ports; and at least k wavelength selective switches connected to the paths on the other side and having at least one input port and at least m output ports. When a first connection number of a b-th output port in an a-th wavelength selective switch connected to the paths on the one side is expressed by f(a, b, k), and a second connection number of a d-th output port in a c-th wavelength selective switch connected to the paths on the other side is expressed by g(c, d, k), f(a, b, k)#g(c, d, k).

Note that the numbers a and d are integers of one to m, and the numbers b and c are integers of one to k.

In the optical communication node of the present invention, the first connection number of the b-th output port in the a-th wavelength selective switch connected to the path on the one side may be expressed by (a−1)×k+b, the second connection number of the d-th output port in the c-th wavelength selective switch connected to the path on the other side may be expressed by (d−1)×k+c, and the output ports with the first connection number and the second connection number having an identical value may be connected with each other.

In the optical communication node of the present invention, the wavelength selective switches connected to the paths on the one side may include at least one lens configured to perform space Fourier transform, at least one diffraction grating, and at least one spatial light modulator, and the wavelength selective switches connected to the paths on the other side may include at least two lenses configured to perform the space Fourier transform, at least one diffraction grating, and at least one spatial light modulator.

In the optical communication node of the present invention, the wavelength selective switches connected to the paths on the one side and the wavelength selective switches connected to the paths on the other side may have one planar lightwave circuit, respectively.

### Effects of Invention

The present invention can provide an optical communication node having low loss and capable of reducing labor and time of a connection work.

### BRIEF DESCRIPTION OF DRAWINGS

FIG. 1 is a schematic view showing the configuration of a WDM node in which a plurality of WSSs mounted on one node.

FIG. 2 is a partial schematic view of the WDM node shown in FIG. 1.

FIG. 3 is a partial schematic view of a WDM node of a first embodiment of the present invention.

FIG. 4 is a schematic view of a connector arrangement of the WDM node shown in FIG. 2.

FIG. 5 is another schematic view of the connector arrangement of the WDM node shown in FIG. 2.

FIG. 6 is a schematic view of a connector arrangement of the WDM node shown in FIG. 3.

FIG. 7 is another schematic view of the connector arrangement of the WDM node shown in FIG. 3.

FIG. 8 is a plan view of a multi-connected integrated WSS in a second embodiment of the present invention.

FIG. 9 is a plan view of an optical waveguide substrate of the multi-connected integrated WSS shown in FIG. 8.

FIG. 10 is a plan view of a modification of the multi-connected integrated WSS shown in FIG. 8.

FIG. 11 is a plan view of the optical waveguide substrate of the multi-connected integrated WSS shown in FIG. 9.

FIG. 12 is a schematic view of a WDM node including the multi-connected integrated WSS shown in FIG. 8 and the multi-connected integrated WSS shown in FIG. 10.

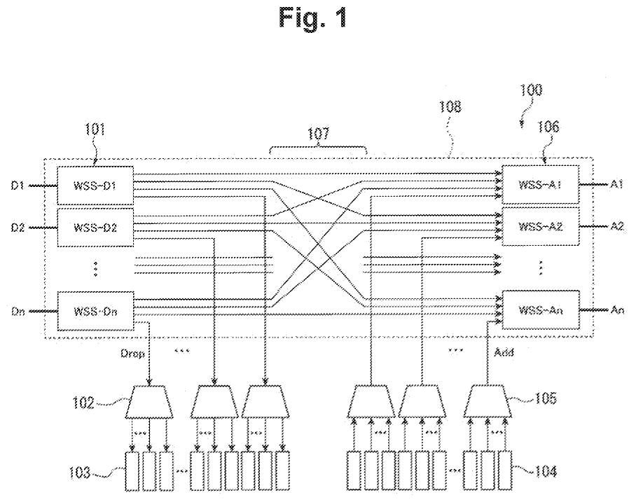

### DESCRIPTION OF EMBODIMENTS

Hereinafter, an optical communication node of one embodiment of the present invention will be described with reference to the drawings.

In this specification and the drawings, component members having the same functions are denoted by the same reference numerals to omit repeated explanation.

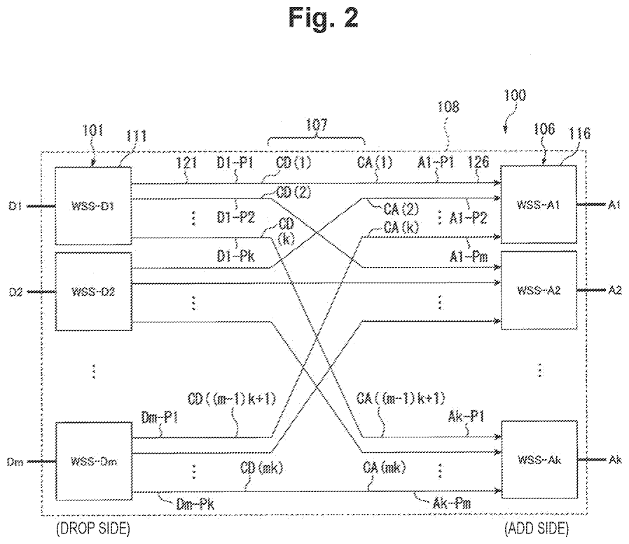

FIG. 2 is a partial schematic view of a WDM node 100. As shown in FIG. 2, in the WDM node 200, WSS groups 101 and 106 are connected to each other via a shuffle wiring unit 107. For the sake of easy understanding of the functions of the WDM node 200, ports and other component members on an Add side and a Drop side are omitted in FIG. 2. Hereinafter, a path connected to an m-th wavelength selective switch (WSS) 111 on the Drop side is described as Dm, and a path connected to a k-th WSS 116 on the Add side is described as Ak. The numbers m and k, which represent any natural numbers equal to or more than two, indicate the destination of an optical signal.

The WSSs 111 each have at least one input port and a plurality of output ports 121.

The WSSs 116 each have at least one input port and a plurality of output ports 126. In this specification and the drawings, the output ports 121 are each denoted by the name of the path connected to each of the WSSs 111 as well as a combination of an initial P and a numerical port number so as to identify each port. For example, a second output port of the WSS 111 which is connected to the path D1 is described as “D1-P2.” In FIG. 2, a first WSS 111 is referred to as WSS-D1.

As shown in FIG. 2, the output ports 121 are wired in order of the smaller numbers to the output ports 126 of the smaller numbers on the Add side. For example, in the case of connecting the path D1 to the path A1, connection is established between the output port D1-P1 of the WSS 111 connected to the path D1 and an output port A1-P1 of the WSS 116 connected to the path A1 on the Add side. Similarly, in the case of connecting between the path Dm on the Drop side and the path Ak on the Add side, an output port Dm-Pk and an output port Ak-Pm are connected. In other words, the port number of each of the output ports 121 signifies the number (destination number) of a path facing across the shuffle wiring unit 107.

Here, a connector number of each connector connected to the WSSs 111 and 116 is introduced. The connector number is allocated for each of the WSSs 111 in the ascending order of the port number. Once the allocation of the connector number to the first WSS 111 is finished, the allocation process shifts to the WSS 111 of a next number, so that the connector number is allocated as a serial number. In the WDM node 200, when a path is increased, the output port 121 and the output ports 126 are also increased in WSS units. Accordingly, close connector numbers are allocated for each WSS 111 and for each WSS 116.

Specifically, as shown in FIG. 2, the output port D1-P1 is connected to a connector CD(1) of the Drop side, and an output port D1-Pk is connected to a connector CD(k). An output port Dm-P1 is connected to a connector CD ((m−1)k+1) on the Drop side, and the output port Dm-Pk is connected to a connector CD(mk). Here, the significance of the numeral in each parenthesis of the connectors CD and CA will be described later.

The output port A1-P1 is connected to a connector CA(1) on the Add side, and an output port A1-Pm is connected to a connector CD(k). An output port Ak-P1 is connected to a connector CA((m−1)k+1), and the output port Ak-Pm is connected to a connector CA(mk). Here, the significance of the numeral in each parenthesis of the connectors CD and CA will be described later.

The numeral in each parenthesis of the connectors CD and CA represents the connector number. Specifically, the connector number (first connection number) of the b-th output port 121 in the a-th WSS 111 is expressed by (a−1)×m+b.

The connector number is sequentially allocated to the connectors CD and CA connected to the same WSS 111 and WSS 116, respectively. Accordingly, when the WSS 116 as the connection destination becomes physically discrete, correspondence relation between the connector number and the port number is eliminated, which necessitates the shuffle wiring unit 107. In other words, in order to omit the shuffle wiring unit 107, it is important to differentiate, in any one of the WSS group 101 and the WSS group 106, the correspondence relation between the connector numbers and the port numbers from the conventional correspondence relation between the connector numbers and the port numbers in the case where the same WSS is used on the Add side and the Drop side.

### First Embodiment

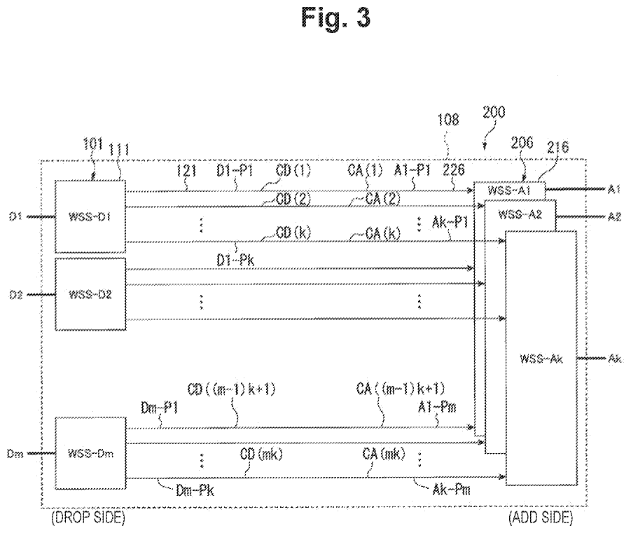

FIG. 3 is a partial schematic view of a WDM node (optical communication node) 200 of a first embodiment of the present invention.

The WDM node 200 on the Drop side is configured in the same manner as the WDM 100 on the Drop side (other side) shown in FIG. 2. In the WSS group 101 on the Drop side, serial and relatively close connector numbers are allocated to the connectors CD connected to the output ports 121 of the same WSS 111, respectively. The connector numbers on the Drop side being relatively close means that difference between the connector numbers is equal to or less than k.

Meanwhile, in the WDM node 200 on the Add side (one side), the correspondence relation between the connector numbers and the port numbers is different from that of the WDM 100. The WSSs 216 each have at least one input port and a plurality of output ports 226. In the WDM node 200, the connector number (second connection number) of the connector CA of a d-th output port 226 in a c-th WSS 216 on the Add side is expressed by (d−1)×k+c. In the WSS group 206 on the Add side, a common port number, and serial and relatively close connector numbers are allocated to the connectors CA connected to each of the WSSs 216. The connector numbers on the Add side being relatively close means that difference between the connector numbers is equal to or less than m.

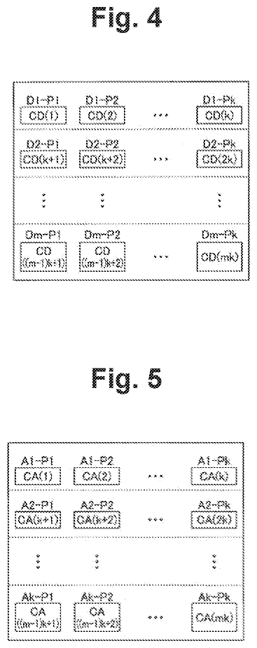

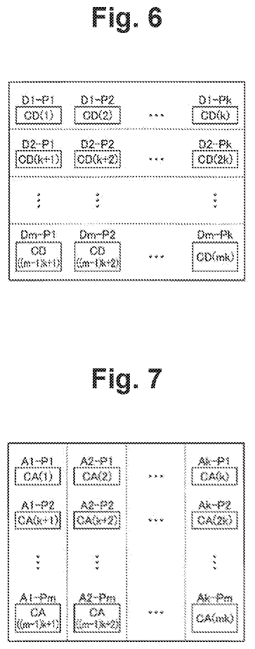

FIGS. 4 and 5 are schematic views of the connector arrangements of the WDM node 100. FIGS. 6 and 7 are schematic views of the connector arrangements of the WDM node 200. In FIGS. 4 to 7, the connector number, which is the smallest on the upper left, becomes larger toward the right side. The connector number on the upper right then shifts to the left end of a next line. In each line, similar numbering is performed in sequence.

FIG. 4 shows the connector arrangement of the WSS group 101 in the WDM node 100 shown in FIG. 2. FIG. 5 shows the connector arrangement of the WSS group 106 in the WDM node 100 shown in FIG. 2. The output ports 121 connected for each WSS 111 and the output ports 126 connected for each WSS 116 are sequentially arranged from the left end toward the right end in FIGS. 4 and 5. In FIGS. 4 and 5, when arrangement of all the output ports 121 of a certain WSS 111 and arrangement of all the output ports 126 of a certain WSS 116 are finished, then in a line immediately below, the connectors CD relating to the WSS 111 having a next number and the connectors CA relating to the WSS 116 having a next number are arranged.

Meanwhile, FIG. 6 shows the connector arrangement of the WSS group 101 in the WDM node 200 shown in FIG. 3. FIG. 7 shows the connector arrangement of the WSS group 206 in the WDM node 200 shown in FIG. 3. Although FIG. 6 is similar to FIG. 4, FIG. 7 shows that the output ports 226 connected for each WSS 216 are sequentially arranged from the upper end toward the lower end. When arrangement of all the output ports 226 of a certain WSS 216 is finished, then in a column immediately on the right, the connectors CA relating to the WSS 216 having a next number are arranged.

Here, the connector number of a b-th output port 121 in an a-th WSS connected to the path on the Add side is expressed as f(a, b, k), and the connector number of a d-th output port 226 in a c-th WSS connected to the path on the Drop side is expressed as g(c, d, k). In this case, in the WDM node 200, f(a, b, k)≠g(c, d, k).

For example, when a=c=1 and b=d=2, f(a, b, k)=f(1, 2, k)=CD(D1-P2)=CD(2). g(c, d, k)=g(1, 2, k)=CA(A1-P2)=CA(k+1). Since k≥2, CD(2)≠CA(k+1). Meanwhile, f(a, b, k)=f(1, 2, k)=CD(D1-P2)=CD(2). Since g(c, d, k)=g(1, 2, k)=CA(A1-P2)=CA (2), CD(2)=CA(2).

As shown in FIGS. 2, 4 and 5, in the WDM node 100, an operator needs to connect between the connectors CD and the connectors CA based on a fixed rule, while paying careful attention to prevent error. As shown in FIGS. 3, 6 and 7, in the WDM node 200, the output ports 121 and 226 having the same connector numbers are connected to each other.

Accordingly, if the connectors CA different in port number and identical in connector number are connected to each of the WSSs 216, the same effect as the conventional shuffle wiring unit 107 can be obtained. In the WDM node 200, since the correspondence relation between the connector numbers and the port numbers is easy to understand, an operator can connect the connectors CA to the WSSs 216 with only a simple checking, and thereby the labor and time of the connection work can be reduced.

Since the PLC for shuffle wiring, or the like is not used, the WDM node 200 can restrain optical loss.

Although the output ports 121 are each connected by a single core connector in FIGS. 4 and 6, the plurality of output ports 121 may collectively be connected with a multicore connector having a plurality of connectors. In that case, the connection work is reduced more. For example, a k-cores connector incorporating the connectors CA with the connector numbers 1 to k may be used. Using multi-fiber push on (MPO) connectors, mechanically transferable (MT) connectors, and the like, can reduce the amount of connection work to 1/k.

### Second Embodiment

The first embodiment is configured on the assumption that the WSSs 111 and the WSSs 216 have the configuration common to each other. However, even when component members of the WSSs 111 and the WSSs 216 are different, the function same as the WDM node 200 of the first embodiment can be implemented.

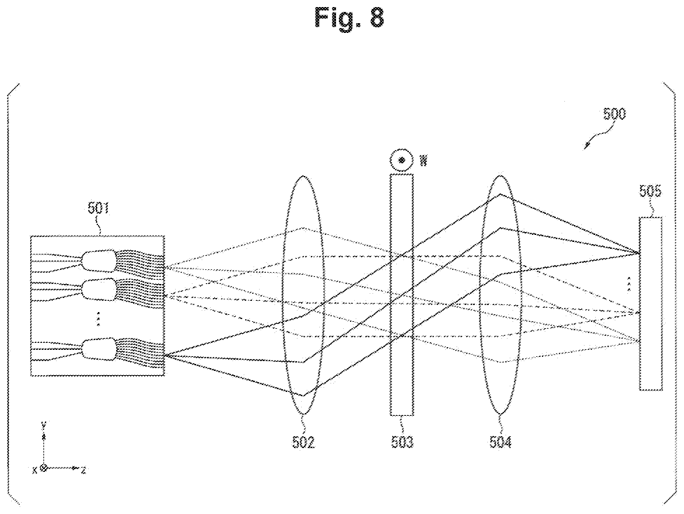

FIG. 8 is a plan view of a multi-connected integrated WSS 500 having the WSS group 101 shown in FIG. 3 integrated therein. As shown in FIG. 8, the multi-connected integrated WSS 500 includes an optical waveguide substrate (planar lightwave circuit) 501, a lens 502, a diffraction grating 503, a lens 504, and a spatial light modulator 505. A free space optical system extending from an end face of the optical waveguide substrate 501 on an exit side to an incident surface of the spatial light modulator 505 is a 4-f optical system. In other words, when a focal length of the lenses 502 and 504 is set to f, the free space optical system is designed based on a 4×f optical length. For the lenses in this specification, a point light source is assumed to be disposed at a position of the focal length of the lenses. Specifically, the lenses 502 and 504 are arranged such that a light source and an image surface are formed at the position of the focal length of each lens so that each of the point light source can be transformed into collimated light (that is, space Fourier transform). For example, a composite focal length fs in the case where the lens with a focal length f1 and the lens with a focal length f2 are arranged at an interval of a distance t can be expressed by following Formula (1).

$$\begin{matrix}[ Formula 1 ] & \\ fs = \frac{{f}_{1} {f}_{2}}{{f}_{1} + {f}_{2} - t} & ( 1 )\end{matrix}$$

Even with use of the above-mentioned two lenses, it is possible to consider that space Fourier transform is performed once and the lenses have the function corresponding to one lens, when the light sources are arranged at the positions corresponding to fs.

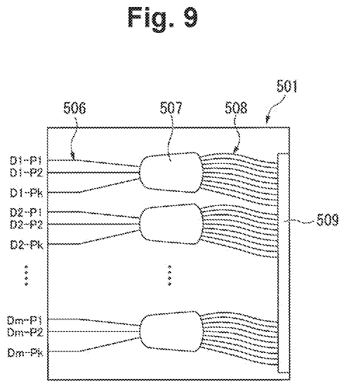

FIG. 9 is a plan view of the optical waveguide substrate 501. As shown in FIG. 9, the optical waveguide substrate 501 includes an input/output waveguide group 506, slab waveguides 507 connected to the input/output waveguide group 506, array waveguides 508 connected to the slab waveguides 507, and a slab waveguide 509 connected to the array waveguides 508.

The array waveguides 508 are all designed to be equal in length. The array waveguides 508 have a function to determine, based on which input/output waveguide is selected out of a plurality of input/output waveguides included in the input/output waveguide group 506, an angle and a beam diameter of an optical beam which passes the optical waveguide substrate 501 and exits to the free space optical system. An optical circuit having such a function is called a spatial beam transformer (SBT).

In the multi-connected integrated WSS 500, an optical signal input from one of the waveguides included in the input/output waveguide group 506 propagates while spreading within the surfaces of the optical waveguide substrate 501 in the state of being confined in an x-axis direction shown in FIG. 8 in the slab waveguide 507. Since a wavefront of the spreading optical signal has a radius of curvature corresponding to a propagating distance, exit ends of the slab waveguides 507 are formed in the shape having a radius of curvature that is identical to the wavefront of the optical signal. The exit ends of the slab waveguides 509 are connected to the array waveguides 508 which are equal in length. Among the end faces of the optical waveguide substrate 501, the end face connected to the array waveguides 508 is parallel to a y-axis.

The optical signals which exit from the array waveguides 508 to the free space optical system via the slab waveguide 509 are plane waves having their phases aligned along the y-axis direction. Accordingly, the optical signals propagate through the space as beams collimated in the y-axis direction. The optical signals are formed into parallel light beams in the lens 502, and angle spectral separation is performed for each wavelength in the diffraction grating 503. The diffraction grating 503 has a wavelength dispersion axis W facing in an x-axis direction. The optical signals spectrally separated for each wavelength pass the lens 504, where angle conversion is performed for each wavelength, and is then incident on the spatial light modulator 505. The lenses 502 and 504 apply space Fourier transform to the optical signals.

The optical signals are reflected by the spatial light modulator 505 at any angle for each wavelength, and are again recoupled into the optical waveguide substrate 501 via the lens 504, the diffraction grating 503, and the lens 502. With the aforementioned operation, switching operation in the multi-connected integrated WSS 500 is completed.

In the aforementioned configuration, a y-axis directional position of the beams collected on the spatial light modulator 505 is determined based on y-axis coordinates of the beams when the beams exit to the free space optical system from the optical waveguide substrate 501, i.e., based on the position of the SBT circuit that the optical signals exit. Accordingly, when the spatial light modulator 505 deflects the beams, which are collected at positions different in y-axis direction from each other, at any angles, the function of the plurality of WSSs can be integrated into one optical system.

In the aforementioned configuration, the optical signals which exit at different angles from one SBT circuit exit to the same position of the spatial light modulator 505. Accordingly, the plurality of output ports 121 in a certain WSS 111 is covered by one SBT circuit. Therefore, the SBT circuits are arranged in the same order as the output ports 121 in the WSS group 101 on the Drop side shown in FIG. 3.

<Modification>

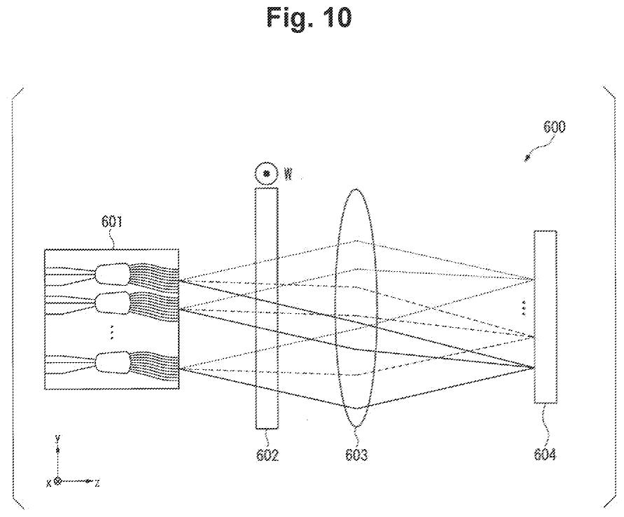

As a modification of the configuration of the multi-connected integrated WSS, a configuration example of a multi-connected integrated WSS with the function included in the WSS group 206 being integrated therein. FIG. 10 is a plan view of a multi-connected integrated WSS 600 as a modification of the multi-connected integrated WSS 500. As shown in FIG. 10, the multi-connected integrated WSS 600 includes one lens 603 in place of the two lenses 502 and 504. The lens 603 performs space Fourier transform of an optical signal like the lenses 502 and 504. Specifically, the multi-connected integrated WSS 600 includes an optical waveguide substrate (planar lightwave circuit) 601, a diffraction grating 602, a lens 603, and a spatial light modulator 604.

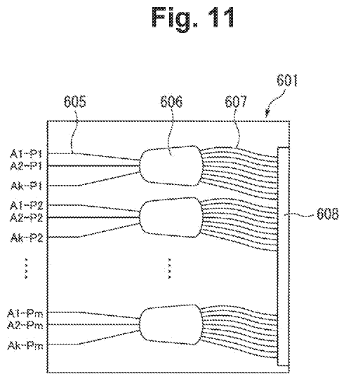

FIG. 11 is a plan view of the optical waveguide substrate 601. As shown in FIG. 11, the optical waveguide substrate 601 has a basic configuration same as the basic configuration of the optical waveguide substrate 501. In the multi-connected integrated WSS 600, in accordance with the angles of the optical signal exiting to the free space as beams, the beams are collected at positions different in the y-axis direction from each other on the spatial light modulator 604.

In the aforementioned configuration, the optical signals exiting from a single SBT circuit at different angles exit to the different positions of the spatial light modulator 604. Accordingly, the plurality of output ports 121 in a certain WSS 111 is not covered by one SBT circuit, but is covered by the different WSSs 111. Therefore, the SBT circuits are arranged in the same order as the port numbers in the WSS group 101 on the Drop side.

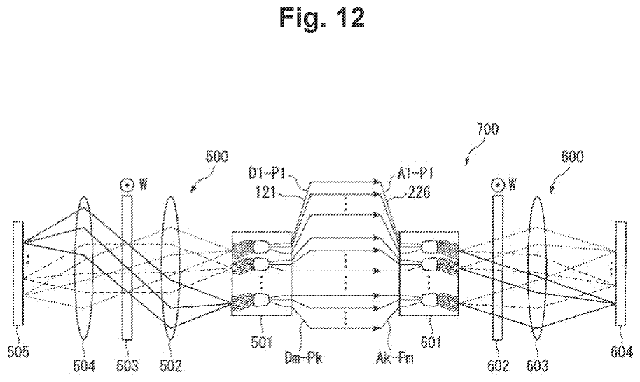

FIG. 12 is a schematic view of a WDM node 700 including the multi-connected integrated WSSs 500 and 600. In the WDM node 700, the multi-connected integrated WSS 500 including a 4-f optical system and the multi-connected integrated WSS 600 including a 2-f optical system face each other across the component members such as the output ports 121 and 226.

In the WDM node 700, an entrance-side end face of the optical waveguide substrate 501 in the multi-connected integrated WSS 500 and an entrance-side end face of the optical waveguide substrate 601 in the multi-connected integrated WSS 600 are connected by the output ports 121, the connectors CD and CA, and the output ports 226 described in the first embodiment. The WDM node 700 can constitute the WDM node without the shuffle wiring unit 107. Also in the WDM node 700, using a k-cores connector can provide simple configuration and reduction in labor and time of the connection work.

Although preferred embodiments of the present invention have been described in the foregoing, the present invention is not limited to the embodiments disclosed. When the configuration of the present invention is provided, deformations and improvements are possible without departing from the range where the object and effects of the present invention can be achieved. Specific structures, shapes, and the like, used for implementing the present invention may be other structures, shapes, and the like, without departing from the range where the object and effects of the present invention can be achieved.

### REFERENCE SIGNS LIST

200, 700 WDM node (optical communication node)
101, 106, 216 WSS (wavelength selective switch)
121, 226 Output port
502, 504, 505 Lens
503, 602 Diffraction grating
505, 604 Spatial light modulator

1. An optical communication node having a plurality of paths on a Drop side and a plurality of paths on an Add side, any one of the paths on the Drop side being freely connectable to any one of the paths on the Add side, the number of the paths on one side out of the Drop side and the Add side being m, the number of the paths on another side out of the Drop side and the Add side being k, and the numbers m and k being natural numbers equal to or more than two, the optical communication node comprising:
at least m wavelength selective switches connected to the paths on the one side and having at least one input port and at least k output ports; and
at least k wavelength selective switches connected to the paths on the other side and having at least one input port and at least m output ports, wherein:
when a first connection number of a b-th output port in an a-th wavelength selective switch connected to the path on the one side is expressed by f(a, b, k), and a second connection number of a d-th output port in a c-th wavelength selective switch connected to the path on the other side is expressed by g(c, d, k),
f(a, b, k)≠g(c, d, k).

2. The optical communication node according to claim 1, wherein
the first connection number of the b-th output port in the a-th wavelength selective switch connected to the path on the one side is expressed by (a−1)×k+b,
the second connection number of the d-th output port in the c-th wavelength selective switch connected to the path on the other side is expressed by (d−1)×k+c, and
the output ports with the first connection number and the second connection number having an identical value are connected to each other.

3. The optical communication node according to claim 1, wherein
the wavelength selective switches connected to the paths on the one side includes
at least one lens configured to perform space Fourier transform,
at least one diffraction grating,
at least one spatial light modulator, and
the wavelength selective switches connected to the paths on the other side includes
at least two lenses configured to perform the space Fourier transform,
at least one diffraction grating, and
at least one spatial light modulator.

4. The optical communication node according to claim 1, wherein
the wavelength selective switches connected to the paths on the one side and the wavelength selective switches connected to the paths on the other side have one planar lightwave circuit, respectively.
